(19) United States
(12) Patent Application Publication
(10) Pub. No.: US 2011/0049070 A1
(43) Pub. Date: Mar. 3, 2011

(54) Portable Shelf System

(76) Inventors: Patrick Sweeney, Acworth, GA (US); Kristin Sweeney, Acworth, GA (US)

(21) Appl. No.: 12/868,255

(22) Filed: Aug. 25, 2010

Related U.S. Application Data
(60) Provisional application No. 61/275,040, filed on Aug. 25, 2009.

(51) Int. Cl. A47B 96/02; F16M 13/00

(52) U.S. Cl. 211/86.01

(57) ABSTRACT

A shelving system for insertion into lockers and other storage facilities in schools, gyms, airports and other transient locations comprised of side walls, adjustable brackets, and shelving all made of a sturdy material. The side walls are placed flush with the interior of a locker while the adjustable brackets are inserted into drilled holes in the side walls via a dowel fastener protruding from the adjustable brackets and the shelves are placed atop the adjustable brackets. The portable shelving system is easily adjusted and manipulated to conform to whatever configuration is desired by the user.

### CROSS REFERENCES TO RELATED APPLICATION

This utility application is the non-provisional application of Provisional Application 61/275,040 filed on Aug. 25, 2009.

US Patent References Cited (* = closest prior art)

U.S. Pat. No. 4,793,664
U.S. Pat. No. 5,154,500
U.S. Pat. No. 6,450,599*
US D522284
U.S. Pat. No. 7,353,958

### BACKGROUND OF THE INVENTION

1. Field of the Invention

This invention is an advancement in portable shelving systems and, more particularly, in shelving systems for purposes of storage of items in lockers through the use of an adjustable stand-alone bracing system and shelves.

2. Description of Related Art

Many methods exist for storing items in schools, gyms, airports, and other transient locations. One of the most common and well known is the locker. There is no lack of locker shelf systems available, but rather there is an absence of sturdy shelf systems available, especially to school age children. Typical middle and high school students are required to store a significant weight of text books, binders, supplies, and sporting equipment in their locker on a daily basis. Students return to their locker several times a day retrieving and returning items and lockers quickly get disorganized.

Locker systems made of wire or hinging frequently buckle under the load placed upon them and more utilitarian shelving systems that are sturdy enough to endure the weight and use placed upon them are often too bulky and cumbersome to qualify as “portable”.

Locker storage systems that are made to pass through the width of the door, which is narrower than the width of the locker, do not maximize the space available inside the locker. Additionally, items tend to fall into the void created by the width differential between the shelving system and the locker itself.

A more desirable system would fit plumb inside of a locker with no space differential, be constructed of sturdy materials capable of enduring the weight of objects placed in a typical locker, would be comprised of adjustable shelves that can be easily manipulated to accommodate the needs of the user, and would be portable so that users could remove and transport the shelving with them when they no longer need the locker.

### BRIEF SUMMARY OF THE INVENTION

This invention represents an advancement in the area of portable shelving systems, particularly for lockers. The shelving system consists of two identical side panels, adjustable brackets, and two shelves, the size of which can vary depending on the specifications of the target locker. The two side panels are constructed of a sturdy material and contain holes drilled into the side panels to support the adjustable brackets. The adjustable brackets have extending from them a dowel fastener which conforms to fit into the holes drilled into the side panels. This permits the user to adjust the height of the shelving. The side panels are placed inside the locker and positioned on the left and right sides of the locker. The adjustable brackets are insetted via the dowel fasteners into the side panel at the desired height for the shelving. The shelves are placed inside the locker by passing through the narrow door opening vertically and then being rotated horizontally and placed atop the adjustable brackets. The shelves are seated atop the adjustable brackets that are inserted into the side panels which then support the shelves and their load. The close fitting relationship between the shelves, the locker walls, and the side panels hold the system securely in place.

### BRIEF DESCRIPTION OF THE DRAWINGS

FIG. 1 shows a complete view of the shelving system installed in a locker showing the positioning of the adjustable brackets and the shelves.

FIG. 2 shows a view of the interior wall of one side panel showing holes drilled into the side panel to accept the dowel fasteners protruding from the adjustable brackets.

FIG. 3 shows a partial cross-sectional view of the side panel showing holes drilled into the side panel to accept the dowel fasteners protruding from the adjustable brackets and shows a cross-sectional view of an adjustable bracket and dowel fastener which fit into the holes.

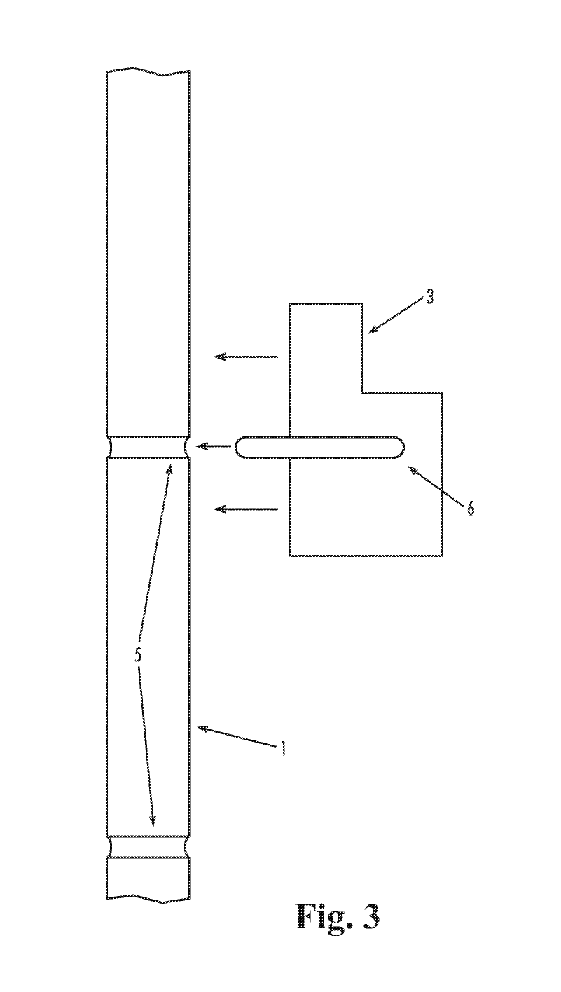

FIG. 4 is a frontal view of the shelving system installed in a locker demonstrating the means of inserting the shelves atop the adjustable brackets.

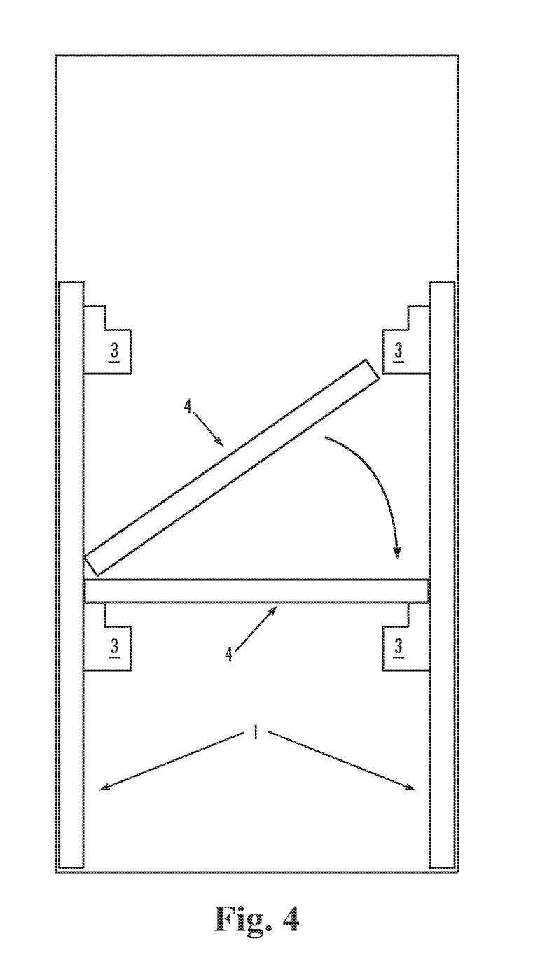

FIGS. 5A, 5B, 5C & 5D show complete views of the shelving system in various configurations installed in lockers.

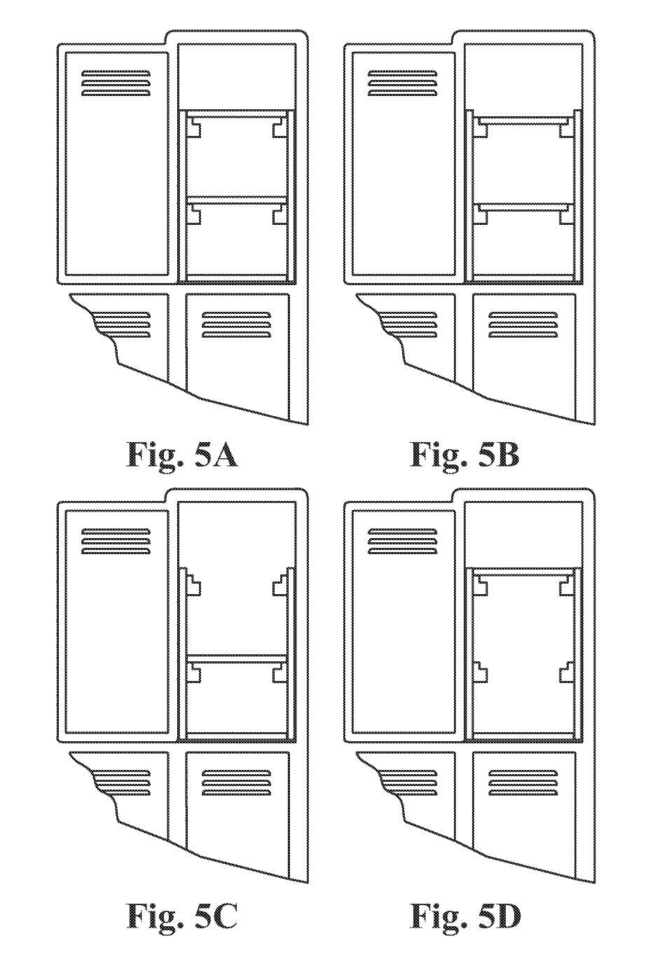

### REFERENCE NUMBERS IN DRAWINGS

1. Side panels
2. Locker
3. Adjustable Brackets
4. Shelves
5. Holes drilled into side panel
6. Dowel fastener

### DETAILED DESCRIPTION OF INVENTION

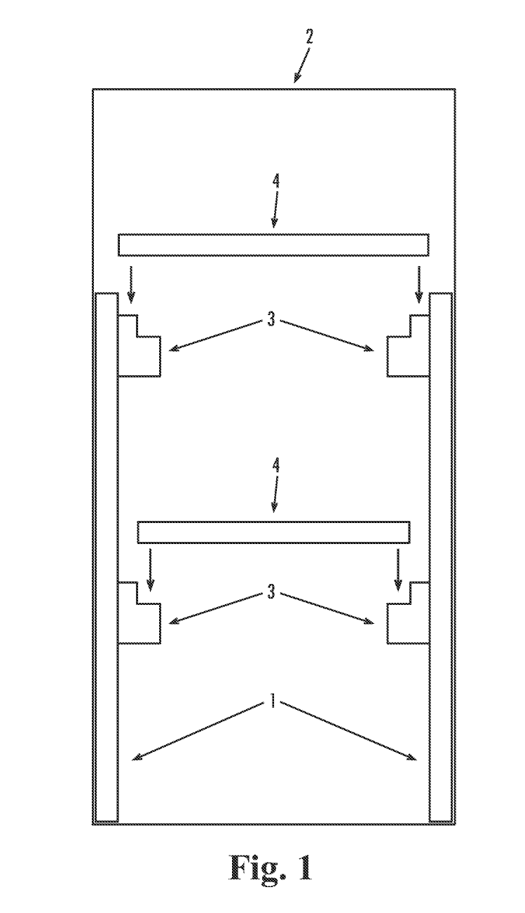

Depicted in FIG. 1 is one embodiment of the portable shelving system presenting features of the present invention. This system consists of two side panels (1) that abut the side of a locker (2) into which adjustable brackets (3) are inserted, and two shelves (4) are placed atop the adjustable brackets.

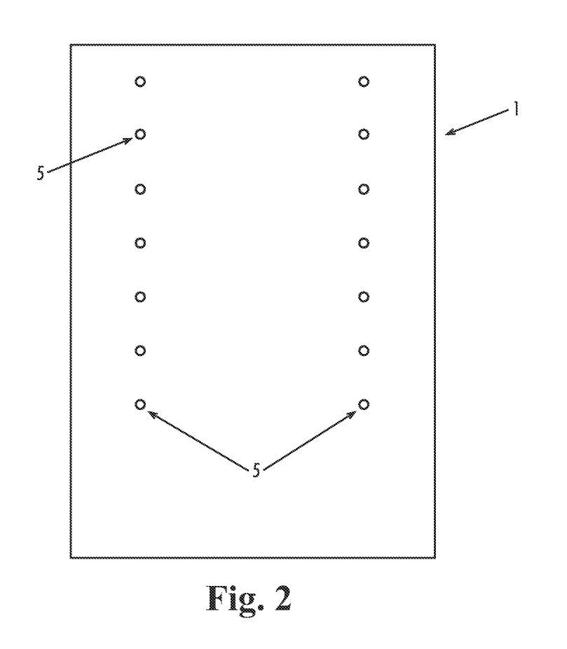

As represented in FIG. 2, the side panels (1) contain numerous drilled holes (5) into which dowel fasteners (6) that protrude from the adjustable brackets (3) are inserted, thereby making the height of the shelves (4) adjustable. The shelving system is inserted into a locker (2) by placing the side walls (1) flush with the left and right walls of the locker (2), and inserting the dowel fasteners (6) that protrude from the adjustable brackets (3) into the holes drilled into the side panel (5) at the desired height. The shelves (4) are then inserted through the door of the locker (2) vertically and rotated horizontally to be placed atop the adjustable brackets (3).

It will be readily apparent to those skilled in the art that a variety of materials can be used to manufacture the side walls (1), the adjustable brackets (3) and the shelves (4). Additionally, it will be readily apparent to those skilled I the art that a variety of methods for adjusting the height of the shelves (4) are possible.

We claim:

1. A portable shelving system capable of being inserted into a locker consisting of:
two side panels,
said side panels being constructed of a sturdy material having holes drilled in a parallel fashion vertically along the side walls,
four adjustable brackets,
said adjustable brackets having a dowel fastener protruding from said adjustable brackets capable of being inserted into the drilled holes of the side panels,
two shelves,
said shelves being capable of placement atop the adjustable brackets.
